(19) United States
(12) Patent Application Publication
(10) Pub. No.: US 2024/0169339 A1
(43) Pub. Date: May 23, 2024

(54) SYSTEM AND METHOD FOR SPREADING PAYMENTS ACROSS A PLURALITY OF PUSH NETWORKS

(71) Applicant: Mastercard International Incorporated, Purchase, NY (US)

(72) Inventors: Jason J Lacoss-Arnold, St. Louis, MO (US); Farah Acharya, Danville, CA (US)

(21) Appl. No.: 18/057,093

(22) Filed: Nov. 18, 2022

(51) Int. Cl. G06Q 20/22; G06Q 20/10; G06Q 20/40

(52) U.S. Cl. CPC G06Q 20/29; G06Q 20/108; G06Q 20/4016

(57) ABSTRACT

A routing computing system configured to receive a request for payment from the client, the request for payment including a payment amount, a specific originating deposit commercial financial institution, and a specific receiving deposit commercial financial institution; determine that the payment amount is greater than the maximum amount limit of each of the plurality of push networks; split the payment amount into a plurality of sub-payments such that each of the plurality of sub-payments does not exceed the maximum amount limit of at least one of the plurality of push networks; assign each of the plurality of sub-payments to a specific one of the plurality of push networks whose maximum amount limit is greater than or equal to an assigned sub-payment.

### FIELD

This application relates to a system and method for spreading payments across a plurality of push networks and, more specifically, to a system and method for selecting a combination of push networks based on the characteristics of each of multiple push networks.

### BACKGROUND

Financial processing networks may encompass a plurality of push networks that interact to provide for multiple processing paths. Push networks may impose specific limits to reduce their losses due to fraud, including limits on daily fund transfers. However, individual financial institutions may wish to allow fund transfers that exceed these limits, at least for some subscribing customers. Because these daily fund transfer limits are network-based, financial institutions cannot make a risk-based decision to raise a funds transfer limit for a particular customer.

### SUMMARY

To address the above-described limitations, a payment system for spreading payments across a plurality of push networks is provided. The payment system comprises a routing computing system comprising at least one processor, a client electronically coupled to the routing computing system, a plurality of originating deposit financial institutions electronically coupled to the routing computing system, a financial processing network electronically coupled to the routing computing system, the financial processing network comprised of a plurality of push networks connecting the routing computing system to a plurality of receiving deposit financial institutions and card-linked accounts, a database in electronic communication with the routing computing system, the database storing and retrieving characteristic data on each of the plurality of push networks, including at least a maximum amount limit. The at least one processor of the routing computing system is configured to receive a request for payment from the client, the request for payment including a payment amount, a specific originating deposit commercial financial institution selected from the plurality of commercial financial institutions, and either a specific receiving deposit commercial financial institution selected from the plurality of commercial financial institutions or a specific card-linked account selected from the plurality of card-linked accounts, retrieve from the database the maximum amount limit for each of the plurality of push networks, determine that the payment amount is greater than the maximum amount limit of each of the plurality of push networks, split the payment amount into a plurality of sub-payments such that each of the plurality of sub-payments does not exceed the maximum amount limit of at least one of the plurality of push networks, assign each of the plurality of sub-payments to specific ones of the plurality of push networks whose maximum amount limit is greater than or equal to the assigned sub-payment, and transmitting each of the plurality of sub-payments through the specific one of the plurality of push networks to which it is assigned from the source commercial financial institution to the destination commercial financial institution.

### BRIEF DESCRIPTION OF THE DRAWINGS

The drawings described below are for illustrative purposes and are not necessarily drawn to scale. The drawings are not intended to limit the scope of the disclosure in any way. Wherever possible, the same or like reference numbers are used throughout the drawings to refer to the same or like parts.

FIG. 1 is a block diagram of a payment system for spreading payments across multiple push networks according to the embodiments disclosed herein.

FIG. 2 is a weighted directed graph for the financial processing network according to the embodiments disclosed herein.

FIG. 3 is a flow diagram of a method for selecting a combination of push networks as a path through a financial processing network for a financial transaction according to the embodiments disclosed herein.

FIG. 4 is a flow chart of a method for generating and evaluating a weighted directed graph for the financial processing network according to the embodiments disclosed herein.

### DETAILED DESCRIPTION

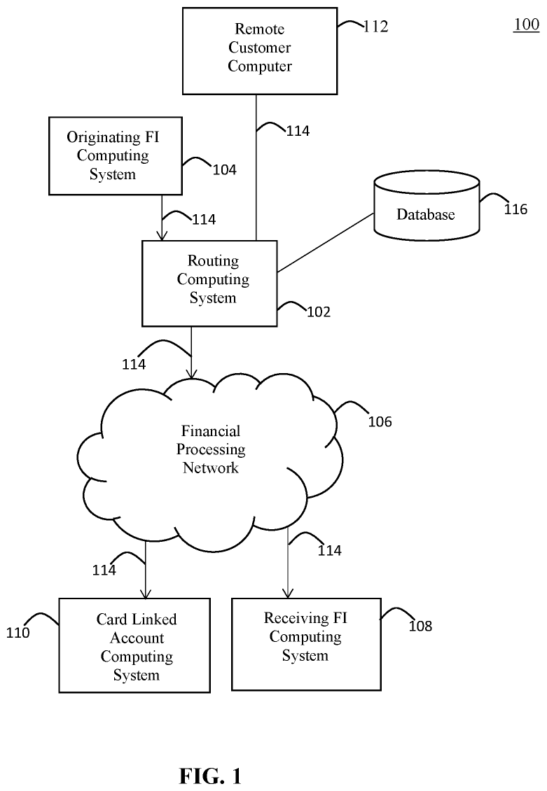

FIG. 1 is a block diagram of a payment system 100 for spreading payments across multiple push networks according to the embodiments disclosed herein. The payment system 100 includes a routing computing system 102 electronically coupled to an originating financial institution computing system 104 and a financial processing network 106. The financial processing network 106 is further electronically coupled to a receiving financial institution computing system 108 and card-linked financial account computing systems 110.

The originating financial institution computing system 104, the receiving financial institution computing system 108, and the card-linked financial account computing systems 110 are each associated with a particular financial institution to store data, such as customer account data, and execute computer-implemented processes such as financial transactions for each financial institution. In particular, the originating financial institution computing system 104 may be associated with a financial institution with an account that serves as the originating or source banking account for a financial transfer through the financial processing network 106. The receiving financial institution computing system 104 may be associated with a financial institution with a banking account that serves as the receiving or destination account for a financial transfer through the financial processing network 106. Similarly, the card-linked financial account computing systems 110 may be associated with a financial institution with a card-linked account that serves as the receiving or destination account for a financial transfer through the financial processing network 106.

The payment system 100 further includes a remote customer computer 112 electrically coupled to the routing computing system 102. The remote customer computer 112 provides customer access to financial transactions implemented by the routing computing system 102 through the financial processing network 106. In particular, a customer may initiate a financial transaction between the originating financial institution computing system 104 and either the receiving financial institution computing system 108 or the card-linked financial account computing systems 110 through the financial processing network 106 by providing instructions to the routing computing system 102 from the remote customer computer 112.

The routing computing system 102 is a gateway between the originating financial institution computing system 104 and the financial processing network 106. The routing computing system 102 may be configured to perform various financial application tasks between the originating financial institution computing system 104 and the receiving financial institution computing system 108 or the card-linked financial account computing systems 110 through the financial processing network 106. As a gateway, the routing computing system 102 implements a routing method that determines how financial transactions are authenticated, processed, and routed through the financial processing network 106. The routing computing system 102 may include any suitable processor-based computing devices, such as one or more processor-based server computing devices and cloud-based computing and storage systems.

As a gateway, the routing computing system 102 is positioned in line with an electronic communications path 114 that communicatively interconnects it with other components with the payment system 100, including the originating financial institution computing system 104, the financial processing network 106, the receiving financial institution computing system 104, the card-linked financial account computing systems 110, and the remote customer computer 112.

The electronic communications path 114 may be comprised of any desired data network type or a combination thereof, including the Internet. Various data network types may be implemented in accordance with the embodiments of the disclosed invention, including a wired or wireless local area network (LAN), a wide area network (WAN), and any other type of network that comprises or is connected to the Internet. When the electronic communications path 114 is implemented as a LAN environment, computing systems may be connected to the LAN through a network interface or adapter. When the electronic communications path 114 is implemented as a WAN network environment, computing devices may connect to the WAN through a modem, router, switch, or other data communication mechanism. The electronic communications path 114 may implement a data communication protocol that may include TCP/IP, UDP, OSI, Ethernet, or any other desired data communication protocol. Computing systems and devices connected to the electronic communications path 114 may communicate through a combination of wired and wireless paths.

The financial processing network 106 may be any network that enables financial transactions commonly employed by financial institutions to handle customer transactions using various channels, including credit cards, debit cards, and bank accounts.

The payment system 100 may further include a database 116 in electronic communication with the routing computing system 102. The database 116 provides for the storage and searchable retrieval of data used to implement the routing method that determines how financial transactions are authenticated, processed, and routed through the financial processing network 106. The database 116 may include a single database, a plurality of separate databases, or a combination of both. Moreover, the database 116 may be located at a single location or multiple locations. The database 116 is accessible to the routing computing system 102 over any direct communications link, including a local area network (LAN) connection. The data stored on the database 116 may be used to implement the claimed method for the routing method that determines how financial transactions are authenticated, processed, and routed through the financial processing network 106.

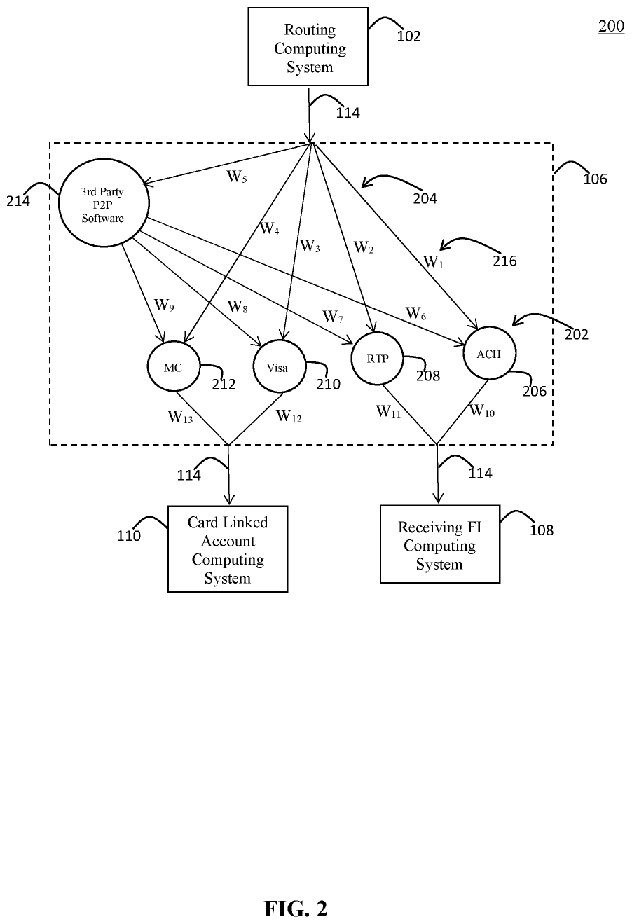

FIG. 2 is a weighted directed graph 200 for the financial processing network 106 according to the embodiments disclosed herein. A plurality of network legs 204 interconnects a plurality of push networks 202 to define available paths for financial transactions through the financial processing network 106.

A plurality of network legs 204 defines the path of a financial transaction through the financial processing network 106 via specific ones of the plurality of push networks 202.

In the embodiment shown in FIG. 2, the plurality of push networks 202 includes the Automated Clearing House (ACH) network 206, the Real-Time Payment (RTP) network 208, the Visa Direct network 210, and the Mastercard Send network 212, as well as third-party peer-to-peer payment networks 214.

However, a person of ordinary skill in the art will recognize that various push other network configurations may comprise the financial processing network 106 while remaining within the scope of the present disclosure.

Each of the plurality of network legs 204 has a specific set of network characteristics that define how a financial transaction is processed through a specific one of the plurality of push networks 202.

The network characteristics may be represented as a scalar variable Wₙ 216 associated with each of the plurality of network legs 204.

The elements comprising the scalar variable W n 216 may include:
a maximum amount;
a cost amount;
a minimum time for funds availability;
a maximum time to settle;
a listing of required data elements;
a listing of supported functions;
a percentage of historic availability;
a percentage of historic approval rate; and
a percentage of historic fraud recovery.

A person of ordinary skill in the art will recognize that other network characteristics may comprise the scalar variable while remaining within the scope of the present disclosure.

The maximum amount element defines a maximum currency amount allowed to be processed at a single time on a specific one of the plurality of network legs 204.

The cost amount element defines the amount charged for each pass through a specific one of the plurality of network legs 204.

The minimum time for funds availability defines the minimum amount of time for funds to become available resulting from a financial transaction implemented on a specific one of the plurality of network legs 204.

The maximum time to settle element defines the maximum amount to complete a financial transaction implemented on a specific one of the plurality of network legs 204.

The listing of required data elements defines the types of data elements a customer must enter to implement a financial transaction on a specific one of the plurality of network legs 204.

The listing of supported functions element defines the different types of financial transactions that may be implemented on a specific one of the plurality of network legs 204.

The percentage of historic availability element defines a percentage that reflects the historical availability of a specific one of the plurality of network legs 204.

The percentage of historic approval rate element defines a percentage that reflects the historical approval rate of a specific one of the plurality of network legs 204.

Lastly, the percentage of historic fraud recovery element defines a percentage that reflects the historical recovery rate of fraudulent financial transactions implemented on a specific one of the plurality of network legs 204.

The routing computing system 102 may store and retrieve the scalar variable Wₙ 216 for each of the plurality of network legs 204 from the database 116. Moreover, the elements comprising each of the scalar variable Wₙ 216 may be updated regularly by the routing computing system 102 based on third-party sources, empirical data, or any other source known to a person of ordinary skill in the art.

The routing computing system 102 may determine an optimum route through the financial processing network 106 for a financial transaction based on the scalar variable W n 216 stored within the database 116.

Specifically, if a funds transfer request received by the routing computing system 102 is for a fund amount that is greater than the maximum amount allowed on all the plurality of push networks 202 comprising the financial processing network 106, the routing computing system 102 may divide the transfer amount into multiple separate transfers to be processed in parallel within the financial processing network 106. In determining which combination of individual ones of the plurality of push networks 202 to use, the routing computing system 102 may use the scalar variable W n 216 of each of the plurality of network legs 204 to select ones from the plurality of network legs 204 to include in the combination of individual ones of the plurality of push networks 202.

Once a funds transfer request has been divided into two or more transfers of smaller amounts, the routing computing system 102 selects two or more specific push networks to process these transfers in parallel. For example, the routing computing system 102 may select two or more individual ones from the plurality of push networks 202 based on the cost associated with each of the network legs 204 comprising each of the plurality of push networks 202. Specifically, the cost amount element of the scalar variable Wₙ 216 associated with each of the plurality of network legs 204 comprising a push network 202 is summed to calculate a total cost for that push network 202. Once the total cost for each of the plurality of push networks 204 has been calculated, two or more specific push networks 202 with the lowest total cost may be selected by the routing computing system 102 for the parallel transfers.

As another example, the routing computing system 102 may select two or more push networks 202 based on the minimum time for funds availability associated with each of the network legs 204 comprising each of the plurality of push network 202. Specifically, the minimum time for funds availability element of the scalar variable W n 216 associated with each of the plurality of network legs 204 comprising a push network 202 is evaluated to determine the actual minimum time for funds availability for that push network 202. Once the actual minimum time for funds availability for each of the plurality of push networks 204 has been determined, two or more specific ones from the plurality of push networks 202 with the lowest minimum time for funds availability may be selected by the routing computing system 102 for the parallel transfers.

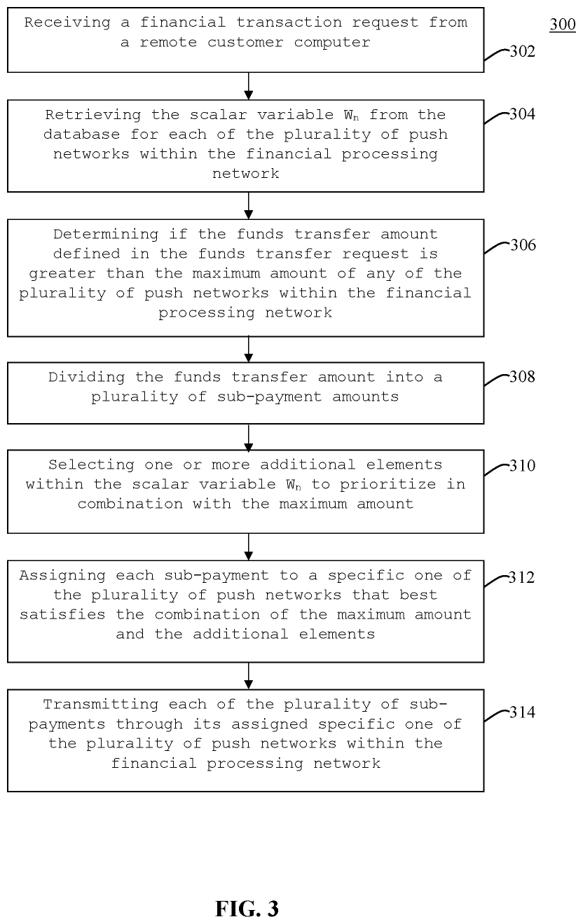

FIG. 3 is a flow diagram of a method 300 for selecting a combination of push networks within a financial processing network to process a financial transaction according to the embodiments disclosed herein.

The method 300 begins, in step 302, with the routing computing system 102 receiving a financial transaction request from a remote customer computer 112. In an exemplary embodiment, the financial transaction is a funds transfer request that includes at least customer identification information, a funds transfer amount, identification information of an originating financial institution, and identification information of a receiving financial institution.

While the specifics of a funds transfer are described, a person of ordinary skill in the art will know that other types of financial transactions may be implemented while remaining within the scope of the present disclosure.

Once the funds transfer request has been received, the method 300 continues, in step 304, with the routing computing system 102 retrieving the scalar variable Wₙ 216 from the database 116 for each of the plurality of push networks 202 within the financial processing network 106.

Once the scalar variables W n 216 have been retrieved, the method 300 continues, in step 306, with the routing computing system 102 determining if the funds transfer amount defined in the funds transfer request is greater than the maximum amount of any of the plurality of push networks 202 within the financial processing network 106.

If it is determined that the funds transfer amount is greater than the maximum amount of any single one of the plurality of push network 202, the method 300 continues, in step 308, with the routing computing system 102 dividing the funds transfer amount into a plurality of sub-payment amounts. Each sub-payment amount being less than the maximum amount of each of the plurality of network legs 204 comprising at least one of the plurality of push networks 202.

Once the plurality of sub-payments amounts has been defined, the method 300 continues, in step 310, with the routing computing system 102 selecting one or more additional elements within the scalar variable W n 216 to prioritize in combination with the maximum amount. The routing computing system 102 will use the additional elements to determine which of the plurality of network legs 204 may be selected to implement the funds transfer request within the financial processing network 106.

Once the additional elements have been selected, the method 300 continues, in step 312, with the routing computing system 102 assigning each sub-payment to a specific one of the plurality of push networks 202 that best satisfies the combination of the maximum amount and the additional elements.

As an example, if the additional element is cost, the routing computing system 102 uses the scalar variables W n 216 to determine which combination of the plurality of network legs 204 has the lowest total costs while maintaining a maximum amount greater than the sub-payment amount.

As another example, if the additional element is the time for funds availability, the routing computing system 102 uses the scalar variables Wₙ 216 to determine which combination of the plurality of network legs 304 has the minimum time for funds availability while maintaining a maximum amount greater than the sub-payment amount.

This same analysis and assignment may be implemented by the routing computing system 102 for any combination of elements defined within the scalar variable W n 216.

Once the sub-payments have been assigned, the method 300 ends, in step 314, with the routing computing system 102 transmitting each of the plurality of sub-payments through its assigned specific one of the plurality of push networks 202 within the financial processing network 106.

In an exemplary embodiment, assigning each sub-payment to a specific one of the plurality of push networks involves generating and evaluating a weighted directed graph for the financial processing network 106.

Specifically, the routing computing system 102 generates a directed graph for the financial processing network 106 in which the vertices represent each of the plurality push networks 202 comprising the financial processing network 106. The edges represent network connections comprising and interconnecting each of the plurality of push networks 202.

Each edge within the directed graph has an associated scalar variable Wn 216 comprised of individual elements that reflect the characteristics of an associated edge within the financial processing network 106.

Within the directed graph, each edge is assigned a numerical weight reflecting the value of an element as stored in the database 116 for that edge.

Specifically, the weight may be a numerical value within a range of numerical values. The lowest weight value is assigned to the edge with the lowest value for a specific element, and the highest weight value is assigned to the edge with the highest value for the same specific element. The remaining weight values within the range are allocated proportionally across the remaining edges based on their corresponding values for the specific element. This same weight assignment may be implemented for each element comprising the scalar variable Wn 216.

For example, the weights may range from 1 to 10. If the cost amount elements across all the edges within the directed graph range from one cent ($0.1) to three dollars ($3.00), then the routing computing system 102 may assign a weight of 1 to the edge with a cost amount of one cent ($0.1) and a weight of 10 to the edge with a cost amount of three dollars ($3.00). The remaining edges are each assigned a weight within the range proportional to their respective cost amount.

In evaluating the available paths through the financial processing network, the routing computing system 102 calculates a cumulative element score for each path through the financial processing network 106 by adding the individual weights for a particular element assigned to the edges within each path.

Moreover, a composite path score may be calculated for each path through the financial processing network 106 by adding the cumulative element score of each element comprising the scalar variable assigned to the edges within each path.

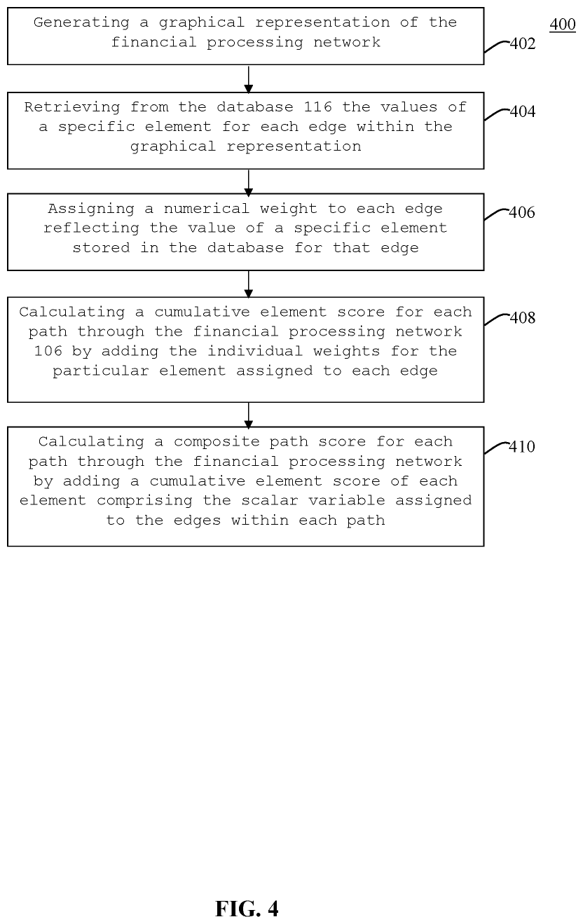

FIG. 4 is a flow chart of a method 400 for generating and evaluating a weighted directed graph of the financial processing network 106 according to the embodiments disclosed herein.

The method 400 begins, in step 402, with the routing computing system 102 generating a directed graph for the financial processing network 106. In the directed graph, the vertices represent the plurality of push networks 202 comprising the financial processing network 106. The edges represent network connections comprising and interconnecting each of the plurality of push networks 202.

The method 400 continues, in step 404, with the routing computing system 102 retrieving from the database 116 the values of a specific element for each edge within the directed graph.

The method 400 continues, in step 406, with the routing computing system 102 assigning a numerical weight to each edge reflecting the value of the specific element of the corresponding edge retrieved from the database 116.

The method 400 continues, in step 408, with the routing computing system 102 calculating a cumulative element score for each path through the financial processing network 106 by adding the individual weights for the particular element assigned to the edges within each path.

Lastly, the method 400 ends, in step 410, with the routing computing system 102 calculating a composite path score for each path through the financial processing network 106 by adding a cumulative element score of each element comprising the scalar variable assigned to the edges within each path.

The foregoing description discloses only example embodiments. Modifications of the above-disclosed assemblies and methods which fall within the scope of this disclosure will be readily apparent to those of ordinary skill in the art.

This disclosure is not intended to limit the invention to the particular assemblies and/or methods disclosed, but, to the contrary, the intention is to cover all modifications, equivalents, and alternatives falling within the scope of the claims.

What is claimed is:

1. A payment management system for spreading payments across a plurality of push networks, comprising:
a routing computing system comprising at least one processor;
a client electronically coupled to the routing computing system;
a plurality of originating deposit financial institutions electronically coupled to the routing computing system;
a financial processing network electronically coupled to the routing computing system, the financial processing network comprised of a plurality of push networks connecting the routing computing system to a plurality of receiving deposit financial institutions and a plurality of card-linked accounts;
a database in electronic communication with the routing computing system, the database storing and retrieving characteristic data on each of the plurality of push networks, including at least a maximum amount limit; and
the at least one processor of the routing computing system configured to:
receive a request for payment from the client, the request for payment including a payment amount, a specific originating deposit commercial financial institution selected from the plurality of originating deposit financial institutions, and either a specific receiving deposit commercial financial institution selected from the plurality of receiving commercial financial institutions or a specific card-linked account selected from the plurality of card-linked accounts;
retrieve from the database the maximum amount limit for each of the plurality of push networks;
determine that the payment amount is greater than the maximum amount limit of each of the plurality of push networks;
split the payment amount into a plurality of sub-payments such that each of the plurality of sub-payments does not exceed the maximum amount limit of at least one of the plurality of push networks;
assign each of the plurality of sub-payments to a specific one of the plurality of push networks whose maximum amount limit is greater than or equal to an assigned sub-payment; and
transmitting each of the plurality of sub-payments through the specific one of the plurality of push networks to which it is assigned from the specific originating deposit commercial financial institution to the specific receiving deposit commercial financial institution.

2. The payment management system of claim 1 wherein the characteristic data on each of the plurality of push networks further includes a cost, a minimum time for fund availability, a maximum time to settle, a required data elements, a functions supported listing, a historic availability percentage, a historic approval rate percentage, and a historic fraud recovery percentage.

3. The payment management system of claim 2
wherein the at least one processor of the routing computing system is further configured to:
retrieve from the characteristic data stored on the database the cost associated with each of the plurality of push networks;
assign each of the plurality of sub-payments to specific ones of the plurality of push networks whose maximum amount limit is greater than or equal to the assigned sub-payment and whose cost is less than or equal to others within the specific ones of the plurality of push networks.

4. The payment management system of claim 2
wherein the at least one processor of the routing computing system is further configured to:
retrieve from the characteristic data stored on the database the minimum time for fund availability associated with each of the plurality of push networks;
assign each of the plurality of sub-payments to specific ones of the plurality of push networks whose maximum amount limit is greater than or equal to the assigned sub-payment and whose minimum time for fund availability is less than or equal to others within the specific ones of the plurality of push networks.

5. The payment management system of claim 2 wherein the at least one processor of the routing computing system is further configured to:
retrieve from the characteristic data stored on the database the maximum time to settle for each of the plurality of push networks; and
assign each of the plurality of sub-payments to specific ones of the plurality of push networks whose maximum amount limit is greater than or equal to the assigned sub-payment and whose maximum time to settle is less than or equal to others within the specific ones of the plurality of push networks.

6. The payment management system of claim 2 wherein the at least one processor of the routing computing system is further configured to:
retrieve from the characteristic data stored on the database the historic availability percentage for each of the plurality of push networks; and
assign each of the plurality of sub-payments to specific ones of the plurality of push networks whose maximum amount limit is greater than or equal to the assigned sub-payment and whose historic availability percentage is greater than or equal to others within the specific ones of the plurality of push networks.

7. The payment management system of claim 2 wherein the at least one processor of the routing computing system is further configured to:
retrieve from the characteristic data stored on the database the historic approval rate percentage for each of the plurality of push networks; and
assign each of the plurality of sub-payments to specific ones of the plurality of push networks whose maximum amount limit is greater than or equal to the assigned sub-payment and whose historic approval rate percentage is greater than or equal to others within the specific ones of the plurality of push networks.

8. The payment management system of claim 2 wherein the at least one processor of the routing computing system is further configured to:
retrieve from the characteristic data stored on the database the historic fraud recovery percentage for each of the plurality of push networks; and
assign each of the plurality of sub-payments to specific ones of the plurality of push networks whose maximum amount limit is greater than or equal to the assigned sub-payment and whose historic fraud recovery percentage is greater than or equal to others within the specific ones of the plurality of push networks.

9. The payment management system of claim 1 wherein the at least one processor of the routing computing system is further configured to:
generate a weighted directed graph for the financial processing network comprised of vertices and edges, the vertices representative of the plurality of push networks, and the edges representative of network connections comprising and interconnection the plurality of push networks; and
calculate a cumulative element score for each path through the financial processing network by adding individual weights for a particular element assigned to the edges within each path within the financial processing network.
